(19) United States
(12) Patent Application Publication
(10) Pub. No.: US 2014/0324552 A1
(43) Pub. Date: Oct. 30, 2014

(54) ANALYSIS AND ANNOTATION OF INTERACTIONS OBTAINED FROM NETWORK TRAFFIC

(71) Applicant: INTERNATIONAL BUSINESS MACHINES CORPORATION, Armonk, NY (US)

(72) Inventors: Yuan-Chi Chang, Armonk, NY (US); Jih-Shyr Yih, Yorktown Heights, NY (US)

(73) Assignee: International Business Machines Corporation, Armonk, NY (US)

(21) Appl. No.: 13/870,311

(22) Filed: Apr. 25, 2013

(51) Int. Cl. G06Q 10/06

(52) U.S. Cl. CPC G06Q 10/06393
USPC 705/7.39

(57) ABSTRACT

A method comprises the steps of obtaining interactions from network traffic for storage in a playback device, analyzing the obtained interactions to determine correlations between the obtained interactions and a knowledge base and annotating the obtained interactions based at least in part on the analysis of the obtained interactions. The obtaining, analyzing, and annotating steps are performed by at least one processing device comprising a processor coupled to a memory.

### FIELD

The field relates to computational analysis and, more particularly to techniques for analysis of interactions between entities.

### BACKGROUND

Various individuals such as clients, customers, managers, etc. desire access to qualitative and quantitative measurements and evaluations of business processes and other interactions in varying conditions. Such individuals also seek insight into potential improvements in business processes and other interactions. Qualitative measurements include determining how processes are completed in specific business conditions and determining whether certain processes achieve goals or other benchmarks set by a business or entity. Quantitative measurements include determining the throughput of processes and the utilization of resources, as well as determining how employees or other individuals perform given certain restrictions defined by the entity. Business and other entities seek to improve management and innovation using such qualitative and quantitative measurements.

### SUMMARY

According to one embodiment of the invention, a method comprises the steps of obtaining interactions from network traffic for storage in a playback device, analyzing the obtained interactions to determine correlations between the obtained interactions and a knowledge base, and annotating the obtained interactions based at least in part on the analysis of the obtained interactions. The obtaining, analyzing, and annotating steps are performed by at least one processing device comprising a processor coupled to a memory.

According to another embodiment of the invention, an apparatus comprises a memory and a processor coupled to the memory. The processor is configured to obtain interactions from network traffic for storage in a playback device, analyze the obtained interactions to determine correlations between the obtained interactions and a knowledge base, and annotate the obtained interactions based at least in part on the analysis of the obtained interactions.

According to another embodiment of the invention, a system comprises a plurality of clients, a plurality of application servers and a processing device comprising a processor coupled to a memory. The processing device under control of the processor is configured to obtain interactions from network traffic for storage in a playback device, analyze the obtained interactions to determine correlations between the obtained interactions and a knowledge base, and annotate the obtained interactions based at least in part on the analysis of the obtained interactions. The obtained network traffic comprises network traffic between respective ones of the clients and the plurality of application servers.

These and other embodiments of the invention will become apparent from the following detailed description of illustrative embodiments thereof, which is to be read in connection with the accompanying drawings.

### BRIEF DESCRIPTION OF THE DRAWINGS

FIG. 1 illustrates a system for analysis of interactions obtained from network traffic, according to an embodiment of the invention.

FIG. 2 illustrates another system for analysis of interactions obtained from network traffic, according to an embodiment of the invention.

FIG. 3 illustrates annotation of a multi-mode session, according to an embodiment of the invention.

FIG. 4 illustrates a methodology for annotation of interactions obtained from network traffic, according to an embodiment of the invention.

FIG. 5 illustrates a methodology for capture and playback of a multi-mode session, according to an embodiment of the invention.

FIG. 6 illustrates a computing device in accordance with which one or more components/steps of techniques of the invention may be implemented, according to an embodiment of the invention.

### DETAILED DESCRIPTION

Illustrative embodiments of the invention may be described herein in the context of illustrative methods, systems and devices for analysis of interactions obtained from network traffic. However, it is to be understood that embodiments of the invention are not limited to the illustrative methods, systems and devices described but instead are more broadly applicable to other suitable methods, systems and devices.

Conventional techniques for analysis of business processes have a number of significant drawbacks. For example, compiling and integrating a number of databases, system logs and other sources of information into a new or dedicated database solely for analysis and evaluation has a number of disadvantages. First, it is difficult and costly to obtain access rights and deal with various schema and formats from a number of disparate sources. Second, this technique may require interruption or other interference with existing databases, system logs and other sources of information, including disruption of server operations. In addition, this technique must assume that the information needed not only exists but is sufficiently complete in order to provide an accurate analysis of business processes.

Another approach involves the capture and construction of a new platform and model for a particular entity. This technique often involves creation of a master plan at a particular point in time. Such master plans may become obsolete quickly as a business or other entity varies or modifies its services and other offerings. In addition, the initial cost of construction of a master plan and platform can significantly outweigh any benefits reaped. As a further disadvantage, monitoring and analytics using such techniques will be tightly coupled with a particular platform.

Various other conventional techniques may be particularly intrusive for customers, employees, and other individuals or entities which interact in business processes. For example, the use of monitoring servers with intrusive agents, or software agents running on users' web browsers or computers may be inconvenient and raise privacy concerns.

Embodiments of the invention provide management and innovation tools which overcome various drawbacks of conventional techniques such as those described above.

Management and innovation tools in embodiments of the invention analyze and annotate information from interactions obtained through the capture of network traffic, including but not limited to traffic such as Hypertext Transfer Protocol (HTTP), IBM 3270 Protocol, and Microsoft Windows Remote Desktop Protocol. Management and innovation tools allow businesses and other entities to investigate and determine the cost, efficiency and other characteristics associated with processes and tasks. For example, such tools can analyze exactly what customers, sales, and services face in particular interactions and how such interactions are resolved in a specific situations. These tools may be configured to store a sequence or set of interactions in order to playback a session of interactions on a playback device. Analysis of business processes allows managers, analysts or other individuals associated with an entity to evaluate the effectiveness of particular processes and to determine ways to fix choke points or breakages in such processes.

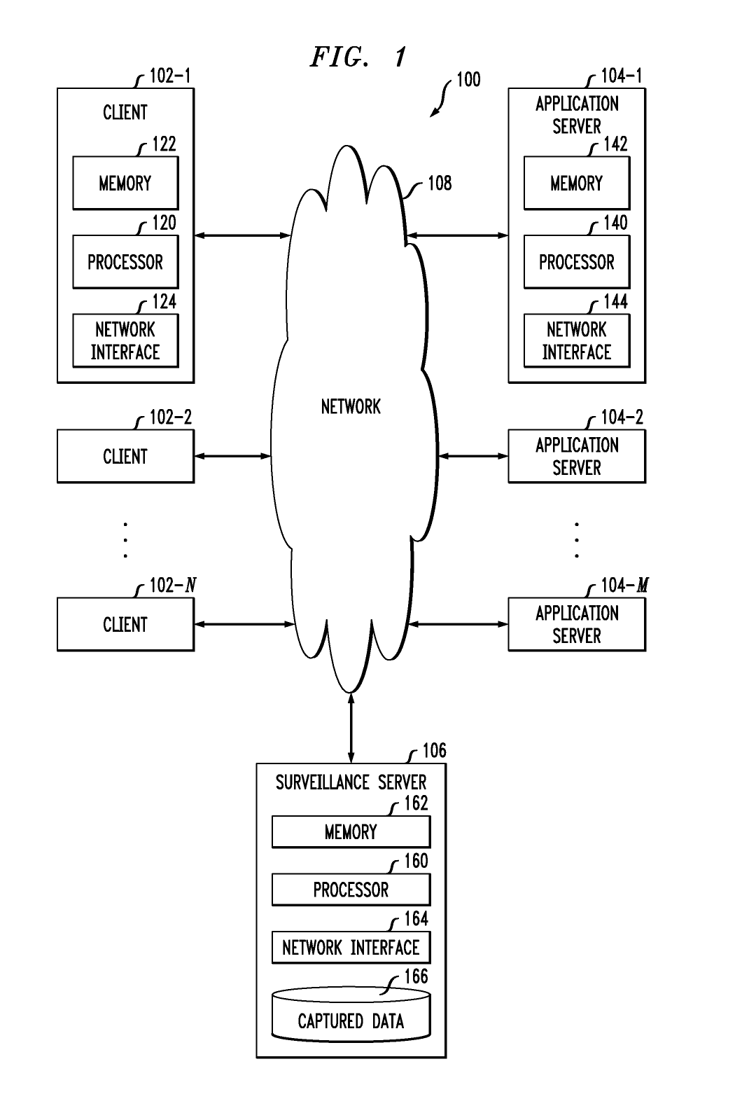

FIG. 1 illustrates a system 100 for analysis and annotation of interactions obtained from network traffic. The system 100 includes a number of clients 102-1, 102-2, . . . 102-N and a number of application servers 104-1, 104-2, . . . 104-M connected to a network 108. A surveillance server 106 is also connected to the network 108. The surveillance server 106 includes captured data 166.

The clients 102 may comprise processing devices utilized by end users of a product, service or application to access one or more of the application servers 104. The clients 102 may comprise personal computers, laptops, mobile telephones, tablets, or various other computing and processing devices. Each of the clients 102 may be associated with a different entity, or two or more of the clients may be associated with the same entity. For example, a given client 102-1 may be a customer of a particular business, an employee of the business, a manager or analyst, etc.

Similarly, the application servers 104 may be associated with one or more different entities. One or more of the clients 102 and one or more of the application servers 104 may be associated with a same entity. It is important to note that the application servers 104 in FIG. 1 need not necessarily provide an “application” to end users such as clients 102. Instead, application servers 104 may be configured to provide any number of or combination of products, services, information, etc.

Client 102-1 comprises a processor 120, a memory 122 and a network interface 124. Application server 104-1 comprises a processor 140, memory 142 and a network interface 124. Surveillance server 106 also comprises a processor 160, memory 162 and a network interface 164. The processors 120, 140, 160 may comprise a microprocessor, a microcontroller, an application-specific integrated circuit (ASIC), a field programmable gate array (FPGA) or other type of processing circuitry, as well as portions or combinations of such circuitry elements. The memories 122, 142, 162 may comprise electronic memory such as random access memory (RAM), read-only memory (ROM), optical and magnetic disks, or other types of memory, in any combination. The network interfaces 124, 144, 164 comprise circuitry and other elements used to interface the client 102-1, application server 104-1 and surveillance server 106 to the network 108 and other system components. Such circuitry may comprise conventional transceivers of a type well known in the art. While not explicitly shown, clients 102-2 to 102-N and application servers 104-2 to 104-M may also comprise processors, memories, and network interfaces as well as other circuitry, components and modules.

The network 108 may be various types of networks, including combinations of network types. Network types include, by way of example, a wide area network (WAN), a local area network (LAN), a satellite network, a public switched telephone network (PSTN) or other telephone network, a cellular network, the Internet, and various portions of combinations of these and other network types.

The number N of clients 102 and the number M of application servers 104 may be any arbitrary number. In addition, while FIG. 1 illustrates a system 100 with only a single network 108 and surveillance server 106, embodiments of the invention include systems with multiple networks and multiple surveillance servers.

The surveillance server 106 in FIG. 1 is configured to obtain interactions between respective ones of the clients 102 and application servers 104 over the network 108. The surveillance server can store the obtained interactions in the captured data 166. Obtained interactions stored in captured data 166 may be annotated and played back so as to provide management and innovation tools accessible to one or more of the clients 102, application servers 104, or other individuals or entities.

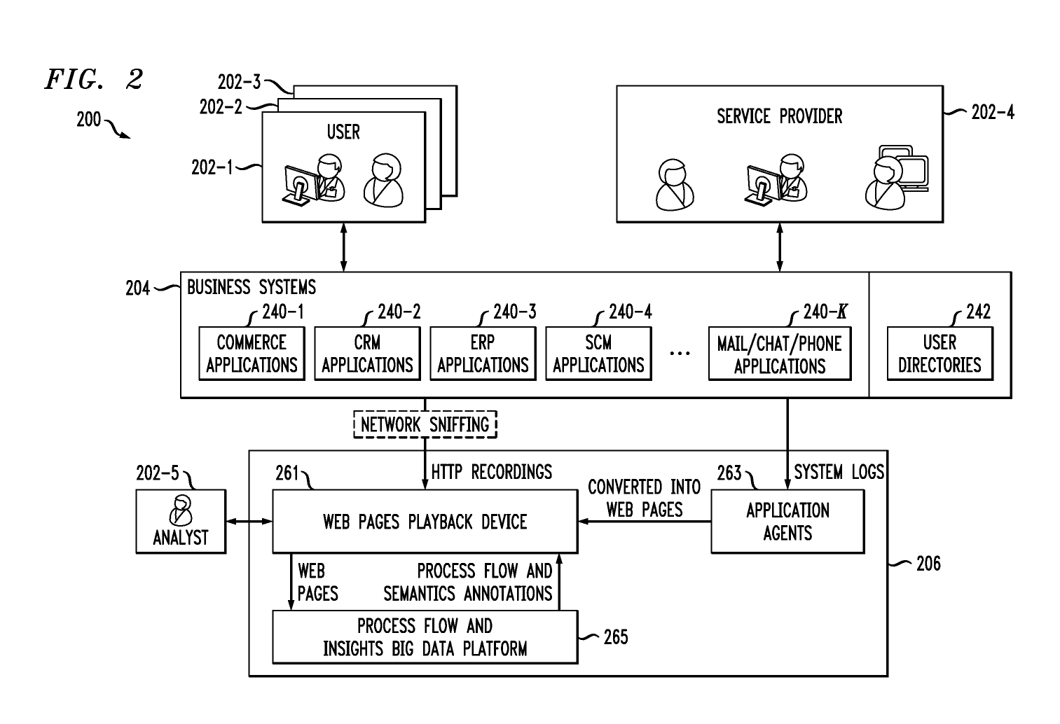

FIG. 2 illustrates a system 200 for obtaining interactions from network traffic. The system 200 includes users 202-1, 202-2 and 202-3. The users 202-1, 202-2 and 202-3 interact with business systems 204. A service provider 202-4 also interacts with business systems 204. The users 202-1, 202-2, 202-3 and service provider 202-4 are examples of the clients 102 shown in system 100 of FIG. 1. The service provider 202-4 may provide a number of services, including by way of examples sales, fulfillment, financial and management services.

Business systems 204 includes a number of applications, including commerce applications 240-1, customer relationship management applications 240-2, enterprise resource planning applications 240-3, supply chain management applications 240-4 and mail, chat and phone applications 240-K. It is important to note that embodiments of the invention are not limited solely to use with the particular applications 240 shown in system 200 in FIG. 2. Instead, a wide variety of other applications and services may be offered by one or more business systems and other entities.

Commerce applications 240-1 allow users 202-1, 202-2 and 202-3 to browse, purchase, sell, trade or obtain other information associated with one or more products and services offered by a given entity. Customer relationship management applications 240-2 allow users 202-1, 202-2 and 202-3 to interact with service provider 202-4. Customer relationship management applications 240-2 may comprise a help desk or other customer service or support applications, which permit customers to interact with customer service agents. Enterprise resource planning applications 240-3 allow service provider 202-4 to manage an entity or services and offerings of one or more entities. Supply chain management applications 240-4 allow service provider 202-4 to view and analyze a supply chain of products and services offered by one or more entities. The mail, chat and phone applications 202-K allow for communication among service provider 202-4 and one or more users 202-1, 202-2 and 202-3. The mail, chat and phone applications 202-K may be used in conjunction with one or more other applications 240 in business systems 204.

It is important to note that while system 200 shows business systems 204 with distinct applications 240, in some embodiments two or more of the applications 240 may be combined, or a single one of the applications 240 may be separated into distinct applications. In addition, a given client such as user 202-1 may interact with a number of applications 240 simultaneously. The applications 240 may also be spread across two or more separate business systems, which may or may not be associated with a same entity.

Business systems 204 further includes user directories 242. User directories 242 may comprise storage personal to the service provider 202-4 or to a given user 202-1, 202-2 or 202-3 or group of users or clients. User directories 242 may store files, emails, chat and phone logs, transaction and order histories, user profiles, and various other information.

A surveillance server 206 is configured to perform network sniffing so as to obtain interactions between clients such as users 202-1, 202-2 and 202-3, service provider 202-4, and the business systems 204. As will be described in further detail below, this network sniffing may be conducted in a non-obtrusive manner. The surveillance server 206 includes web pages playback device 261, application agents 263, and process flow and insights big data platform 265.

The web pages playback device 261 may perform network sniffing to record HTTP interactions in the form of web pages. For example, the applications 240 may provide web interfaces for clients 202, and the web pages playback device 261 can capture the particular web pages seen by a client such as user 202-1 as the user 202-1 interacts with one or more of the applications 240. The web pages playback device 261 may utilize transmission control protocol (TCP)/internet protocol (IP) network streams for capture. The web pages playback device 261 in some embodiments is configured so as to only capture interactions with the applications 240, and not all interactions of a given client such as user 202-1. This advantageously reduces privacy concerns and eliminates unnecessary storage of unrelated or extraneous interactions not associated with a given process.

Application agents 263 may retrieve system logs from mail, chat and phone applications 240-K. Application agents 263 may also retrieve information from other applications 240 associated with a given process other than particular web pages seen by a client. Application agents 263 are configured to convert the system logs and other information into one or more web pages for storage in the web pages playback device 261.

Process flow and insights big data platform 265 is configured to retrieve web pages stored in the web pages playback device 261 and to assemble the retrieved web pages into a process flow comprising a sequence of web pages. The process flow and insights big data platform 265 is also configured to annotate the sequence of web pages, by determining correlations, transitions and other semantics between the sequence of web pages in a given process flow and the information stored in a knowledge base. The process flow and insights big data platform 265 is configured to store the process flow and annotations in the web pages playback device 261.

As described above, the process flow and insights big data platform 265 may annotate a sequence of web pages in a given process flow using information from a knowledge base. Such a knowledge base may be what is referred to herein as a “big data” platform. A big data platform is a management system that provides the large capacity and analytical functions to continuously ingest, disseminate, store, correlate, and retrieve sniffed network traffic data. The knowledge base, which may be a big data platform, can include information from a number of distinct sources associated with a number of entities, which provides semantic labeling in the context of the applications. For example, a supply chain application has business user screens to submit an invoice and check the status of an order. Semantic labels associated with the screens can be defined and correlated with the sniffed network traffic. The big data platform may be dynamic, in that particular sources of information may be added and removed over time.

Analyst 202-5 may communicate with the web pages playback device 261 in order to view one or more web pages stored therein. The analyst 202-5 may retrieve a particular process flow, with or without annotations, to analyze. The analyst 202-5 may alternately specify a particular type or class of process and retrieve a group of process flows or portions thereof which relate to the specified process type or class. This advantageously allows analyst 202-5 to determine the effectiveness of particular processes, and to compare the most common ways in which a process is resolved, or to determine why particular instances of a process required an exceptional resolution.

The surveillance server 206, using web pages playback device 261, application agents 263 and process flow and insights big data platform 265, is configured to record full interactions as digitized clips. The surveillance server 206 can capture and reconstruct interactions associated with one or more process flows. As discussed above, the web pages playback device 261 can capture and store particular web pages visited by a given client, while application agents 263 can capture and store information from non-web media such as server logs, emails, chat logs, phone calls, faxes, etc. The surveillance server 206 is thus able to correlate what clients see and hear and how clients talk and act in the context of a particular process. The surveillance server 206 is able to use a knowledge base such as the process flow and insights big data platform 265 to annotate interactions with information relating to successes, losses, struggles, errors, complaints, feedback, etc. Analysis, managers and other clients can use annotations and correlations to act on-the-fly in responding to existing cases and new cases based on detected patterns.

Embodiments of the invention can utilize surveillance servers such as surveillance server 106 in system 100 of FIG. 1 or surveillance server 206 in system 200 of FIG. 2 to perform a number of tasks. For example, embodiments can reason client-system interactions in a process, thus enabling the discovery of flows of execution for particular types of cases to provide insight and education on how a particular process is performed. Such reasoning can be used to trace the execution of cases or processes, and to compare a particular case or process with references cases and processes. This allows individuals and entities to debug processes or otherwise determine why respective processes are successful or unsuccessful. Such reasoning can also allow individuals and other entities to experiment with an existing or new process to determine potential improvements.

As another example, embodiments can measure processes and cases. Individuals and entities can define queries to measure various characteristics of a given process, asset, service, product, division, etc. Queries can be used to determine process throughput, compare individual, team or brand performance with respect to specified goals, and compare to established benchmarks for a given process. Embodiments can also proactively fix breakages, slowdowns, bottlenecks, choke points and other issues in processes. An individual or entity can be messaged or otherwise notified in a timely manner so as to invoke particular services or query and gather information to speed resolution of a process or improve the quality or other characteristics of processes.

Thus, embodiments of the invention allow managers, analysts and other individuals or entities to innovate through analysis and review of what and how customers, employees and other individuals see and act, screen-by-screen, page-by-page, media clip-by-media clip, in a meaningful correlated context of the manager, analyst or other individual or entity's choice. Play-by-play details and summarizing trend analytics allow for innovation, education, management, and connecting-the-dots of particular processes. This smart surveillance for activities and interactions associated with a business or other entity may be performed in a manner which does not intrude on personal activities of a given client on a personal device or machine. In some embodiments, only interactions between a client and application servers associated with a given entity are recorded and reconstructed for analysis and annotation. The use of big data analytics provides for intelligent annotation of the recorded and captured interactions.

A given process or case may involve a number of clients, individuals and entities. As one example, an entity may be an insurance company, and a process or case may be an insurance claim. Various individuals may interact with one another to take a particular insurance claim from filing to closure. Interactions may include a number of sessions, which may be of multiple types. By way of example, a customer may initially report a claim by phone. The customer may later upload evidence or other documents relating to the claim over a network such as the Internet or via a fax machine. The customer may communicate with one or more representatives of an insurance company through e-mails, telephone calls, web chats, etc. to resolve issues which arise from filing the claim to closure of the claim. Thus, a given process or case such as an insurance claim may be what is referred to herein as a multi-mode session, in that the process or case comprises two or more sessions of different types. Embodiments of the invention can capture interactions associated with sessions of different types, group these sessions together as a multi-mode session, and annotate the multi-mode session for analysis during or after completion of the case or process.

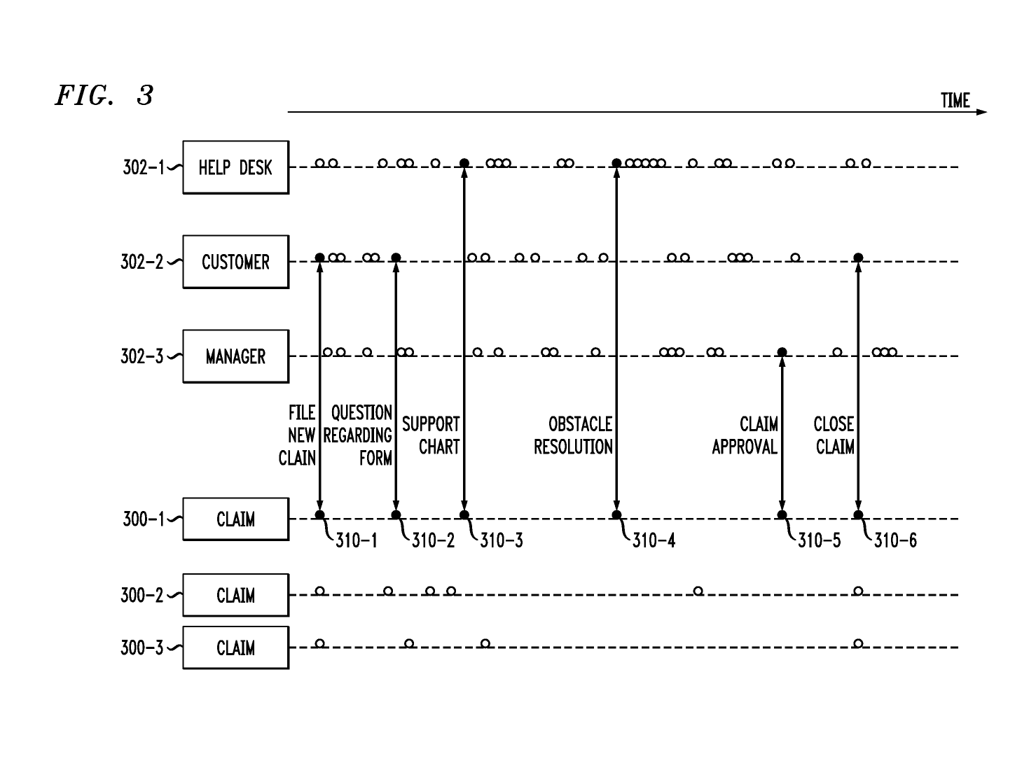

FIG. 3 illustrates annotation of a multi-mode session. In FIG. 3, clients such as help desk 302-1, customer 302-2 and manager 302-2 interact with one another in the resolution of a claim 300-1. It is important to note that although FIG. 3 is described below with respect to annotation of insurance claims, embodiments of the invention are not limited solely to capture and annotation of insurance claims. Instead, embodiments are more generally applicable to a variety of processes, cases, etc. between clients, entities and application servers, such as credit card inquiry and resolution, electronic commerce order and fulfillment, and mortgage request and approval. The interactions of claim 300-1 are represented by filled in circles in FIG. 3, while interactions associated with other claims such as claims 300-2 and 300-3 are represented by hollow circles in FIG. 3.

Claim 300-1 includes a number of interactions 310. The first interaction 310-1 in claim 300-1 is the customer 302-2 filing a claim. The second interaction 310-2 is the customer 302-2 formulating a question regarding a form for the claim 300-1. In response to interaction 310-2, the help desk 302-1 initiates interaction 310-3, a support chat between the help desk 302-1 and the customer 302-2 in claim 300-1. Once the help desk 302-1 understands the nature of the question or difficulty regarding the form, the help desk 302-1 begins interaction 310-4, placing a support phone call to the customer 302-2 to resolve the customer 302-2's issue in the claim 300-1. The next interaction 310-5 in claim 300-1 is approval of the insurance claim. The last interaction 310-6 of claim 300-1 is closure of the claim.

The claim 300-1 is a multi-mode session, in that the various interactions 310 comprise sessions of different types. For example, the interactions 310-1, 310-3, 310-5 and 310-6 may be web-based interactions, with the customer 202-2 and manager 202-3 interacting with one or more applications servers of a given entity using a web interface. The interaction 310-3 may be a phone call which is recorded and the interaction 310-4 may be a chat log. The interactions 310-3 and 310-4 may be converted into one or more web pages for storage in a playback device. Additional interactions may involve recording through IBM 3270 terminals, Citrix Remote Desktop Protocol, and various other interfaces.

FIG. 3 also shows claims 300-2 and 300-3. Claims 300-1, 300-2 and 300-3 may all be returned responsive to a playback search. By way of example, a playback search in the context of FIG. 3 may be for insurance claims over a certain dollar amount, or insurance claims of a particular type such as fire, flood or theft, or claims from a particular geographic region or time and date. A playback search may also specify a particular customer, employee, manager, etc. In FIG. 3, the claims 300-1, 300-2 and 300-3 are returned by a particular search. The claims 300-1, 300-2 and 300-3 have similar characteristics, but may be resolved differently. Key performance indicators may be annotated in the claims 300-1, 300-2 and 300-3. Claim 300-1 may be annotated based on analysis and annotations of claims 300-2 and 300-3. The annotations in claims 300-2 and 300-3 may also be updated based on analysis of claim 300-1.

The results of a playback search may also be utilized by one or more individuals or entities such as the help desk 302-1 or the manager 302-3 in resolving claim 300-1. For example, the help desk 302-1 may look at interactions in claims 300-2 and 300-3 to determine how to resolve the customer's question in interaction 310-4. The manager 302-3 may look at claims 300-2 and 300-3 in determining whether to approve claim 300-1 in interaction 310-5. As will be appreciated by one skilled in the art, various other examples are possible.

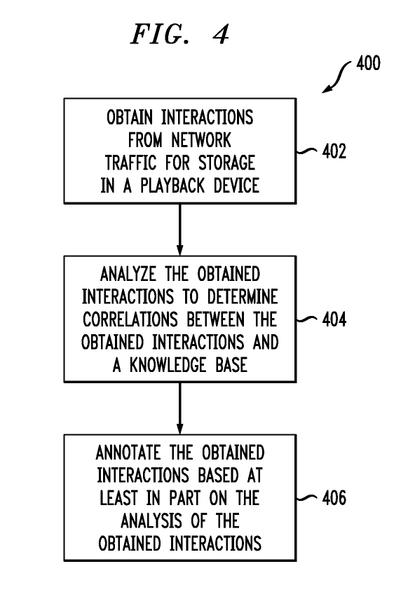

FIG. 4 illustrates a methodology 400 for annotation of interactions obtained from network traffic. Methodology 400 begins with step 402, obtaining interactions from network traffic for storage in a playback device. Next, the obtained interactions are analyzed 404 to determine correlations between the obtained interactions and a knowledge base. The knowledge base may include information relating to one or more previous interactions between clients and application servers associated with an entity. The methodology 400 concludes with annotating 406 the obtained interactions based at least in part on the analysis of the obtained interactions.

As discussed above, a given case or process may be a multi-mode session comprising one or more sessions of different types. Each session in the multi-mode session includes at least one interaction. Session types include, by way of example, web pages, emails, chat logs, faxes and phone calls. In some embodiments, analyzing the obtained interactions in step 404 may include identifying a case identifier associated with one or more sessions of the obtained interactions. Sessions having a same case identifier can be ordered based on timestamps associated with the sessions. Such ordering may include ordering the sessions chronologically. In other embodiments, the sessions may be ordered by the time taken in a particular session. By way of example, it may be helpful in certain instances to determine which sessions or session types consume the most amount of time. To reduce bottlenecks and the total time taken to finish a process or resolve a case, analysis of the most costly session types can be useful for structuring future responses in similar cases and processes.

Analyzing the obtained interactions in step 404 may further include determining whether respective ones of the sessions which have a same case identifier comprise common interactions or exception interactions. Frequency thresholds may be used for determining whether particular interactions are classified as common or exception interactions. For example, if a frequency of occurrence of a given interaction exceeds a threshold, it may be considered a common interaction. Conversely, if the frequency of occurrence of a given interaction is at or below a threshold the given session may be considered an exception interaction. Identification of common and exception interactions may be useful in a number of contexts, as will be described in further detail below.

Other factors may also be used in classifying a particular interaction as a common or exception interaction. For example, the amount of time taken for a particular interaction may be used to classify interactions as common or exception interactions. As another example, the identity of one or more clients involved in a particular interaction may be indicative of whether an interaction is a common or exception interaction. For example, if a manager is involved in an interaction which is normally performed by an employee that the manager supervises, the interaction may be an exception interaction.

Common interactions having the same case identifier can be grouped based on transition probabilities between interactions. Since actual instances in a process are likely to differ depending on the context or condition of the case, certain steps may be skipped or exception handling may be invoked. Transition probability is defined as the likelihood of moving from the current step to one of the next allowed steps. A high transition probability implies the majority of instances take the step while a low transition probability suggests the step may be rare. Analysis of the knowledge base or other information may indicate that interactions of particular types are often followed by interactions of other types. For example, analysis of a knowledge base may indicate that web chats or emails are typically followed by telephone support calls, or that web-based interactions with one application server are typically followed by web-based interaction with another application server. This analysis can be used to determine transition probabilities between interactions of certain types. Grouping common sessions may further comprise ordering the common sessions temporally for annotation.

After grouping common interactions, one or more groups of interactions may be matched with one or more reference templates stored in a knowledge base. A reference template may comprise a model of a process or case from inception to resolution. The model may indicate frequencies of interactions and transition probabilities between interactions in the at least one process. Models may be constructed from analysis of existing or past processes and cases using information stored in the knowledge base. The reference template may include annotations regarding interactions in the model process. After a group of common sessions is matched to a reference template, the annotations associated with the one or more reference templates may be updated based on information from the group of common sessions. It is important to note that more than one group of common sessions may be matched to a particular reference template, and that a particular group of common sessions may be matched to two or more reference templates.

Annotating the obtained interactions in step 406 may further include comparing a given multi-mode session to a set of reference templates stored in a knowledge base. The given multi-mode session can be matched to a given one of the reference templates and annotated based at least in part on information from the given reference template. A particular multi-mode session may be matched to two or more reference templates in some embodiments of the invention.

Multi-mode sessions can be matched to reference templates using correlation thresholds. For example, a correlation between common interactions in the multi-mode session and interactions in the reference templates may be used to determine correlations between multi-mode sessions and reference templates. In some embodiments, the multi-mode session may be matched to the reference template with the highest correlation threshold. In other embodiments, the multi-mode session may be matched to a subset of two or more reference templates with the highest correlation thresholds. The multi-mode session may be annotated using information from the two or more reference templates, or a user may be prompted to select between the two or more reference templates. The annotation of a multi-mode session may be completely automated in some embodiments. In other embodiments, the automated annotation may be supplemented or replaced with human annotation.

In some embodiments, exception interactions may be used in part to match multi-mode sessions to reference templates, or to choose between two or more reference templates with similar correlation thresholds. The exception interactions in a particular multi-mode session may also be flagged for further review by an analyst, manager, or other individual associated with an entity. Exception interactions may indicate that a particular multi-mode session had a unique success or problem, bottleneck, choke point, etc. Analysis of the exception interactions may be utilized for improving process models and reference templates. By way of example, in a particular multi-mode session, an exception interaction may combine or simplify a sequence of two or more common interactions in a reference template. Thus, managers and analysts can modify application servers or inform employees and other staff that the use of the exception session is preferred for future cases and processes.

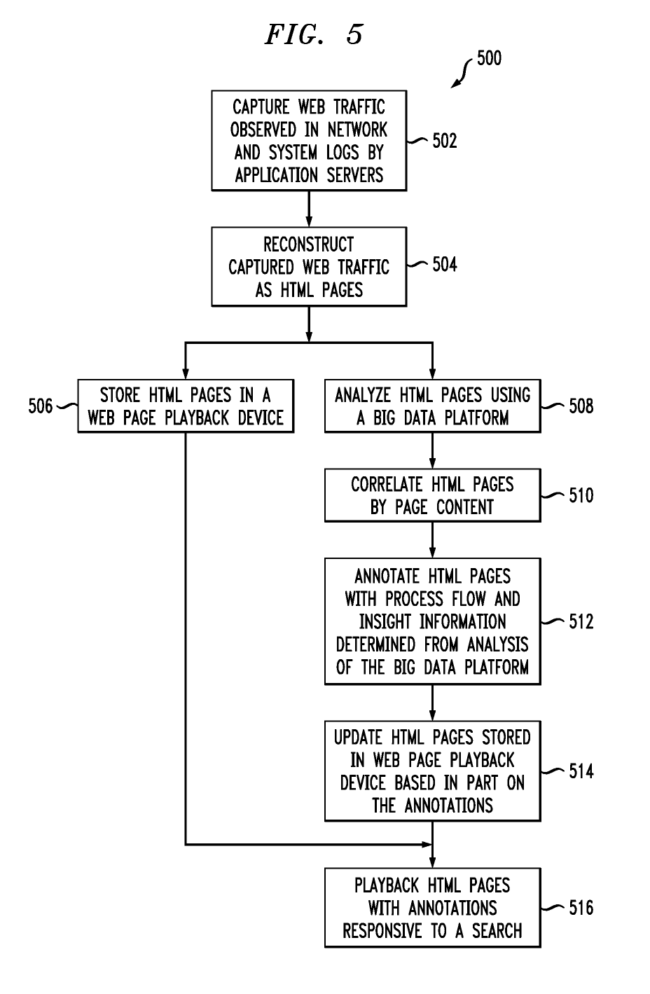

FIG. 5 illustrates a methodology 500 for capture and playback of a multi-mode session. The methodology 500 begins with the capture of web traffic observed in a network and system logs by application servers in step 502. It is important to note that in some embodiments, network traffic may be captured from two or more distinct networks, or combinations of network types. In step 504, the captured web traffic is reconstructed as HyperText Markup Language (HTML) pages. Some of the captured web traffic may include interactions which are already in the form of HTML pages, and thus no reconstruction is necessary. Other captured traffic may include interactions in the form of system logs, emails, chat logs, phone calls, etc. which are reconstructed as HTML pages. It is important to note that embodiments of the invention are not limited solely to reconstruction of web traffic as HTML pages. Instead, embodiments of the invention may reconstruct web traffic as one or more documents or files in a variety of other forms, such as slideshows, text documents, videos, etc.

In step 506, the HTML pages are stored in a web page playback device. The HTML pages are analyzed 508 using a big data platform. In some embodiments, knowledge bases other than or in addition to big data platforms may be used in step 508. The HTML pages are then correlated 510 by page content. The HTML pages are annotated 512 with process flow and insight information determined from analysis of the big data platform. Next, the HTML pages stored in the web page playback device are updated 514 based in part on the annotations. In step 516, the HTML pages are played back with their respective annotations responsive to a search.

As will be appreciated by one skilled in the art, aspects of the present invention may be embodied as a system, apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be but are not limited to, for example, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a RAM, a ROM, an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smailtalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

Aspects of the present invention are described herein with reference to flowchart illustrations and/or block diagrams of methods, apparatus, systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring again to FIGS. 1-5, the diagrams in the figures illustrate the architecture, functionality, and operation of possible implementations of systems, methods and computer program products according to various embodiments of the present invention. In this regard, each block in a flowchart or a block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagram and/or flowchart illustration, and combinations of blocks in the block diagram and/or flowchart illustration, can be implemented by special purpose hardware-based systems that perform the specified functions or acts, or combinations of special purpose hardware and computer instructions.

Accordingly, techniques of the invention, for example, as depicted in FIGS. 1-5, can also include, as described herein, providing a system, wherein the system includes distinct modules (e.g., modules comprising software, hardware or software and hardware).

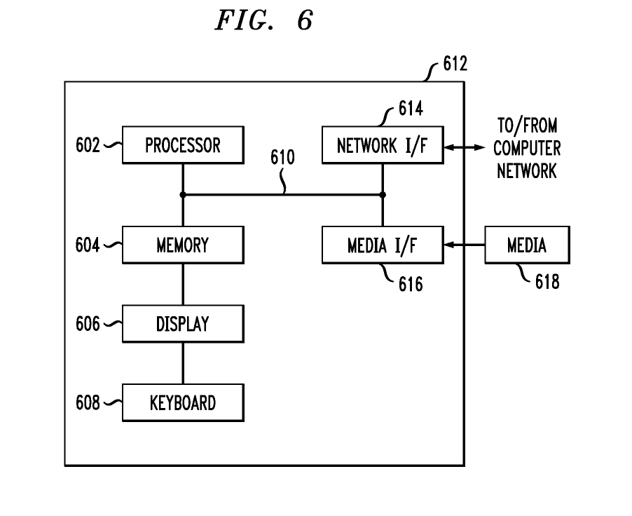

One or more embodiments can make use of software running on a general purpose computer or workstation. With reference to FIG. 6, such an implementation may employ, for example, a processor 602, a memory 604, and an input/output interface formed, for example, by a display 606 and a keyboard 608. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM, ROM, a fixed memory device (for example, hard drive), a removable memory device (for example, diskette), a flash memory and the like. In addition, the phrase “input/output interface” as used herein, is intended to optionally include, for example, one or more mechanisms for inputting data to the processing unit (for example, keyboard or mouse), and one or more mechanisms for providing results associated with the processing unit (for example, display or printer).

The processor 602, memory 604, and input/output interface such as a display 606 and keyboard 608 can be interconnected, for example, via bus 610 as part of data processing unit 612. Suitable interconnections, for example, via bus 610, can also be provided to a network interface 614, such as a network card, which can be provided to interface with a computer network, and to a media interface 616, such as a diskette or CD-ROM drive, which can be provided to interface with media 618.

A data processing system suitable for storing and/or executing program code can include at least one processor 602 coupled directly or indirectly to memory elements 604 through a system bus 610. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboard 608 for making data entries; display 606 for viewing data; a pointing device for selecting data; and the like) can be coupled to the system either directly (such as via bus 610) or through intervening I/O controllers (omitted for clarity).

Network adapters such as a network interface 614 may also be coupled to the system to enable the data processing system to become coupled to other data processing systems or remote printers or storage devices through intervening private or public networks. Moderns, cable modern and Ethernet cards are just a few of the currently available types of network adapters.

As used herein, a “server” includes a physical data processing system (for example, system 612 as shown in FIG. 6) running a server program. It will be understood that such a physical server may or may not include a display and keyboard. Further, it is to be understood that components may be implemented on one server or on more than one server.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

1. A method comprising the steps of:
obtaining interactions from network traffic for storage in a playback device;
analyzing the obtained interactions to determine correlations between the obtained interactions and a knowledge base; and
annotating the obtained interactions based at least in part on the analysis of the obtained interactions;
wherein the obtaining, analyzing, and annotating steps are performed by at least one processing device comprising a processor coupled to a memory.

2. The method of claim 1, wherein the knowledge base comprises information relating to processes in one or more previous interactions.

3. The method of claim 1, wherein the network traffic comprises interactions between one or more clients and one or more application servers associated with a given entity.

4. The method of claim 3, wherein one or more application servers comprise two or more of:
a commerce system;
a customer relationship management system;
an enterprise resource planning system;
a supply chain management system; and
an email, chat or phone system.

5. The method of claim 1, wherein the obtained interactions comprise one or more multi-mode sessions, a given one of the multi-mode sessions comprising two or more sessions of different types, each session comprising at least one interaction.

6. The method of claim 5, wherein session types comprise web pages, emails, chat logs and phone calls.

7. The method of claim 5, wherein obtaining interactions comprises reconstructing one or more interactions associated with a given case as a sequence of web pages.

8. The method of claim 5, wherein analyzing the obtained interactions comprises:
identifying a case identifier associated with one or more sessions of the obtained interactions;
ordering sessions having a same case identifier based at least in part on timestamps associated with the sessions;
determining whether respective ones of sessions having the same case identifier comprise common interactions or exception interactions; and
grouping common interactions having the same case identifier based at least in part on transition probabilities between interactions;
wherein a given interaction is a common interaction if a frequency of occurrence associated with the given interaction exceeds a given threshold and wherein the given interaction is an exception interaction if the frequency of occurrence associated with the given interaction is at or below the given threshold.

9. The method of claim 8, further comprising:
matching one or more groups of common interactions with one or more reference templates stored in the knowledge base; and
updating annotations associated with the one or more reference templates based at least in part on information from the one or more groups of common interactions.

10. The method of claim 5, wherein annotating the obtained network traffic comprises:
comparing the given multi-mode session to a set of reference templates stored in the knowledge base;
matching the given multi-mode session to a given one of the reference templates; and
annotating the given multi-mode session based at least in part on information from the given reference template.

11. The method of claim 10, further comprising measuring correlation thresholds between the given multi-mode session and respective ones of the reference templates.

12. The method of claim 11, wherein matching the given multi-mode session to the given reference template is based at least in part on the measured correlation thresholds.

13. The method of claim 11, wherein matching the given multi-mode session comprises:
prompting a user to select the given reference template from a subset of the reference templates, the subset of the reference templates being determined based at least in part on the measured correlation thresholds; and
matching the given multi-mode session to the given reference template responsive to user selection of the given reference template.

14. The method of claim 11, wherein a given one of the reference templates comprises a model of at least one process, the model comprising information regarding frequencies of one or more interactions and transition probabilities between interactions in the at least one process.

15. The method of claim 1, wherein obtaining the network traffic comprises nonintrusive capturing of interactions from network traffic associated with one or more application servers of a given entity.

16. The method of claim 1, wherein the obtained interactions comprise interactions from network traffic associated with two or more different networks.

17. The method of claim 16, wherein the two or more different networks comprise networks of two or more different types, the different types comprising two or more of: the internet, a local area network, a cellular network and a public switched telephone network.

18-20. (canceled)
